(19) United States
(12) Patent Application Publication
(10) Pub. No.: US 2026/0159106 A1
(43) Pub. Date: Jun. 11, 2026

(54) System and Method for Calibrating a Telematics Device Using Vehicle Data

(71) Applicant: Bendix Commercial Vehicle Systems LLC, Avon, OH (US)

(72) Inventors: Andrew J. Pilkington, Avon Lake, OH (US); Justin R. Miller, Elyria, OH (US)

(73) Assignee: Bendix Commercial Vehicle Systems LLC, Avon, OH (US)

(21) Appl. No.: 18/976,555

(22) Filed: Dec. 11, 2024

(51) Int. Cl. B60W 50/06

(52) U.S. Cl. CPC B60W 50/06; B60W 2556/45; B60W 2756/10

(57) ABSTRACT

A system and method are provided for calibrating a telematics device using vehicle data. In one embodiment, a telematics calibration system receives a value from a sensor in a telematics device, receives a value from a sensor in a vehicle, compares the value from the sensor in the telematics device with the value from the sensor in the vehicle to identify a difference, and uses the difference to calibrate the telematics device. Other embodiments are provided.

### BACKGROUND

Some commercial vehicles (e.g., a truck or a tractor (“towing vehicle”) capable of towing a trailer) have a variety of sensors (e.g., an accelerometer, a steer-angle sensor, a wheel-speed sensor, etc.) that can be used to assist in the operation of the vehicle. For example, a brake controller in the vehicle can use collected sensor data to provide anti-lock braking functionality. Additionally, some commercial vehicles have an integrated driver assistance system that can use collected sensor data to provide collision mitigation capabilities and advanced driver assistance features to improve safety. The collected sensor data can be communicated via the vehicle's internal controller area network (CAN) using the Society of Automotive Engineers (SAE) J1939 communications standard.

Aftermarket telematics devices are available that can be installed behind the rear-view mirror of the vehicle or in other locations, such as the dash, the headliner, and the side mirrors (for blind spot monitoring). A telematics device can include road-facing and driver-facing cameras, an inertial motion unit (IMU) with sensors (e.g., an accelerometer, gyroscope, and compass) to detect movement, audio/visual output devices, and processor(s) running artificial intelligence/machine-learning algorithms. The telematics device can also be connected to the vehicle's internal controller area network(s) (CAN(s)) to collect vehicle data. In operation, the video recorded by the cameras and the data from the IMU's sensors are processed in real-time to detect events related to driving and driver behavior (e.g., vehicle speeding/acceleration, vehicle swerving, hard braking, vehicle having too close of a following distance (time to collision), a distracted or drowsy driver, etc.). When an event is detected, the telematics device can present an audio/visual alert to the driver and can wirelessly send information about the detected event to a fleet manager or other entity external to the vehicle.

### BRIEF DESCRIPTION OF THE DRAWINGS

FIG. 1 is a block diagram of example components of a vehicle of an embodiment.

FIG. 2 is a block diagram of a telematics calibration system of an embodiment.

FIG. 3 is a flow chart of a method of an embodiment for calibrating a telematics device.

### SUMMARY

A system and method are provided for correlating or calibrating devices on a commercial vehicle. In one embodiment, a method for calibrated a telematics device is provided that is performed in a telematics calibration system. The method comprises: receiving a value from a sensor in a telematics device; receiving a value from a sensor in a vehicle; comparing the value from the sensor in the telematics device with the value from the sensor in the vehicle to identify a difference; and calibrating the telematics device using the difference.

In another embodiment, a non-transitory computer-readable storage medium is provided that stores a computer program having instructions that, when executed by one or more processors, cause the one or more processors, individually or in combination, to: receive data from an aftermarket telematics device; receive data from an integrated vehicle component; correlate the data received from the aftermarket telematics device with the data received from the integrated vehicle component; and calibrate the telematics device based on the correlation.

In yet another embodiment, a system is provided comprising: one or more processors; a non-transitory computer-readable medium; and program instructions stored on the non-transitory computer-readable medium that, when executed by the one or more processors, cause the one or more processors to: receive data from a telematics device; receive data from a vehicle component; correlate the data received from the telematics device with the data received from the vehicle component; and calibrate the telematics device based on the correlation.

Other embodiments are possible, and each of the embodiments can be used alone or together in combination.

### DETAILED DESCRIPTION

As mentioned above, some commercial vehicles (e.g., a truck or a tractor (“towing vehicle”) capable of towing a trailer) have a variety of sensors (e.g., an accelerometer, a steer-angle sensor, a wheel-speed sensor, etc.) that can be used to assist in the operation of the vehicle. For example, a brake controller in the vehicle can use collected sensor data to provide anti-lock braking functionality. Additionally, some commercial vehicles have an integrated driver assistance system that can use collected sensor data to provide collision mitigation capabilities and advanced driver assistance features to improve safety. The collected sensor data can be communicated via the vehicle's internal controller area network (CAN) using the J1939 communications standard.

Aftermarket telematics devices are available that can be installed behind the rear-view mirror of the vehicle or in other locations, such as the dash, the headliner, and the side mirrors (for blind spot monitoring). A telematics device can include road-facing and driver-facing cameras, an inertial motion unit (IMU) with sensors (e.g., an accelerometer, gyroscope, and compass) to detect movement, audio/visual output devices, and processor(s) running artificial intelligence/machine-learning algorithms. The telematics device can also be connected to the vehicle's internal controller area network(s) (CAN(s)) to collect vehicle data. In operation, the video recorded by the cameras and the data from the IMU's sensors are processed in real-time to detect events related to driving and driver behavior (e.g., vehicle speeding/acceleration, vehicle swerving, hard braking, vehicle having too close of a following distance (time to collision), a distracted or drowsy driver, etc.). When an event is detected, the telematics device can present an audio/visual alert to the driver and can wirelessly send information about the detected event to a fleet manager or other entity external to the vehicle.

Aftermarket telematics devices can have several limitations. For example, a telematics device is often mounted on the vehicle's windshield. In this position, readings from the accelerometer can be amplified due to vehicle suspension dynamics. Also, the telematics device's accelerometer may be limited in range and/or accuracy as compared to the vehicle's own internal accelerometer. As a result, the output of the telematics device can be inaccurate, resulting in a false alert or in not providing an alert that should otherwise be provided.

The following embodiments can be used to address this problem. In general, these embodiments can be used to calibrate or correlate data reported by an aftermarket telematics device against data from integrated vehicle components, such as, but not limited to, an acceleration sensor and a wheel speed sensor. (An acceleration sensor can be, for example, an accelerometer or a proxy sensor, such as optical inputs (e.g., a camera) and algorithms to calculate acceleration.) For example, these embodiments can be used to compare the acceleration measured by the telematics device with the acceleration calculated by the vehicle's brake controller and self-calibrate the telematics device accordingly. This can be beneficial, for example, when the telematics device is installed on the vehicle's windshield (which can cause data from the accelerometer in the telematics device to be suspect due to amplification caused be vehicle suspension dynamics) and/or when the accelerometer is otherwise not as accurate or sensitive as the vehicle's own accelerometer. As another example, the time-to-collision (TTC) value calculated by the telematics device can be compared and calibrated to a time-to-collision value reported by the vehicle's driver assistance system. While these are just a couple of examples, it should be noted that these embodiments can be applied to any other suitable data, such as, but not limited to, yaw rate and the data provided in the below use cases. These embodiments can also provide more-accurate reporting of data from the host vehicle to be used in the back office.

The following paragraphs provide example use cases of these embodiments. It should be understood that these are merely examples and that other implementations can be used. Also, while these examples are described in terms of calibrating a telematics device, it should be noted that these embodiments can be used to calibrate other components in the vehicle. As such, the details provided herein should not be read into the claims unless expressly recited therein.

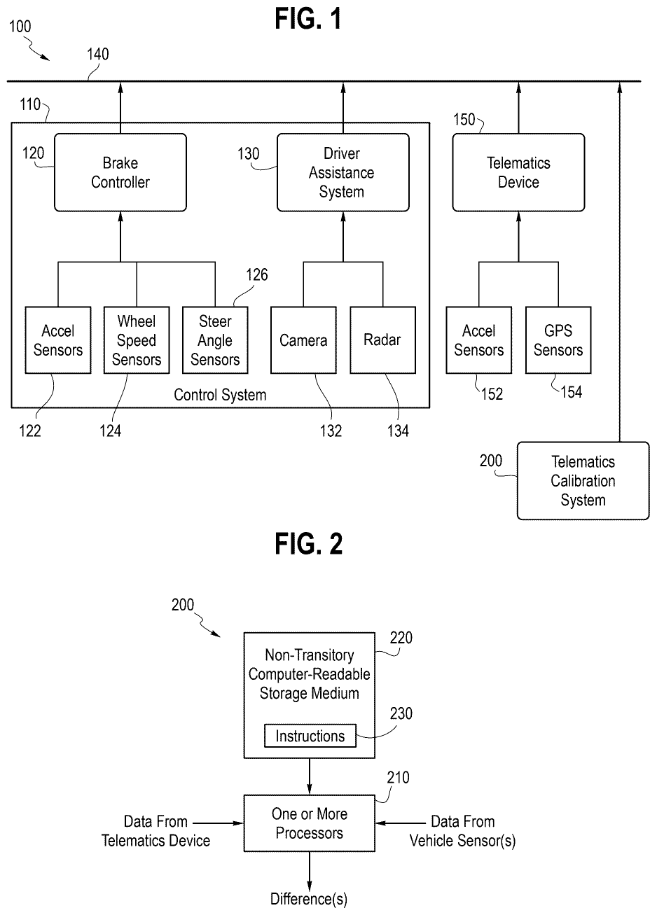

Turning now to the drawings, FIG. 1 a block diagram of example components of a vehicle 100 of an embodiment. As shown in FIG. 1, these example components include a control system 110, which includes a brake controller 120 and a driver assistance system 130 coupled to a communications network 140 in the vehicle 100. The communications network 140 can be, for example, a controller area network (CAN) operating under the J1939 communications standard.

The brake controller 120 can comprise one or more processors that can, individually or in combination, execute instructions stored in a non-transitory computer-readable storage medium to provide various braking functionality, such as, but not limited to, anti-lock braking, based on inputs from one or more sensors in the vehicle 100. These sensors can include, but are not limited to, acceleration sensors 122 (e.g., an accelerometer), wheel speed sensors 124, and steer angle sensors 126. The driver assistance system 130 can comprise one or more processors that can, individually or in combination, execute instructions stored in a non-transitory computer-readable storage medium to provide various functions to assist a driver (e.g., collision mitigation) based on inputs from one or more sensors in the vehicle 100. These sensors can include, but are not limited to, a camera 132 and a radar 134.

It should be noted that there can be additional or different controllers and/or sensors on the vehicle 100. For example, the vehicle 100 can comprise a turn signal sensor, a driver accelerator pedal sensor, an engine sensor to detect revolutions per minute (RPM), etc.

In this example, the vehicle 100 also comprises an aftermarket telematics device 150 that is also connected to the communications network 140. The telematics device 150 has its own acceleration sensors 152 (e.g., an accelerometer) and global positioning system (GPS) sensors 154. As described above, the acceleration sensors 152 (and possibly other sensors) in the telematics device 150 may not be as accurate as the vehicle's own corresponding sensors. Also, the telematics device 105 may lack sensors found in the vehicle 100 (e.g., the wheel speed and steer angle sensors 132, 134), which can limit the accuracy of reporting of the position, speed, lateral acceleration, and/or longitudinal acceleration of the vehicle through the telematics device 150.

In this embodiment, a telematics calibration system 200 is provided to improve the accuracy of the telematics device 150 by calibrating the telematics device 130 using vehicle data. In this example implementation, the telematics calibration system 200 is a component in the vehicle 100 and is not part of the telematics device 150. In other example implementations, the telematics calibration system 200 is part of the telematics device 150 or is located external to the vehicle 100 (e.g., in a server hosted by a manufacture of the telematics device 150).

FIG. 2 shows an example implementation of the telematics calibration system 200. This is just an example, and other implementations can be used. As shown in FIG. 2, in this embodiment, the telematics calibration system 200 comprises one or more processors 210 in communication with a non-transitory computer-readable storage medium 220, where “medium” can refer to one or more memories (e.g., volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof). The non-transitory computer-readable storage medium 220 stores a computer program having instructions 230 (e.g., modules, routines, sub-routines, programs, applications, etc.). The one or more processors 210 can also take the form of a purely-hardware implementation (e.g., an application-specific integrated circuit (ASIC)).

The instructions 230 when executed by the one or more processors 210, individually or in combination, cause the one or more processors 210 to perform the functions described below (and, optionally, other functions). For example, the instructions 230 when executed by the one or more processors 210, individually or in combination, can cause the one or more processors 210 to compare data from the telematics device 150 with data from one or more vehicle sensors to output difference(s), which can be used to calibrate the telematics device 150. As used herein, the phrase “calibrate the telematics device” can refer to, for example, re-performing an operation of the telematics device 150 to account for the difference, adjusting an output of the telematics device 150 to account for the difference, retraining an algorithm used by the telematics device 150 to account for the difference, or any other suitable action.

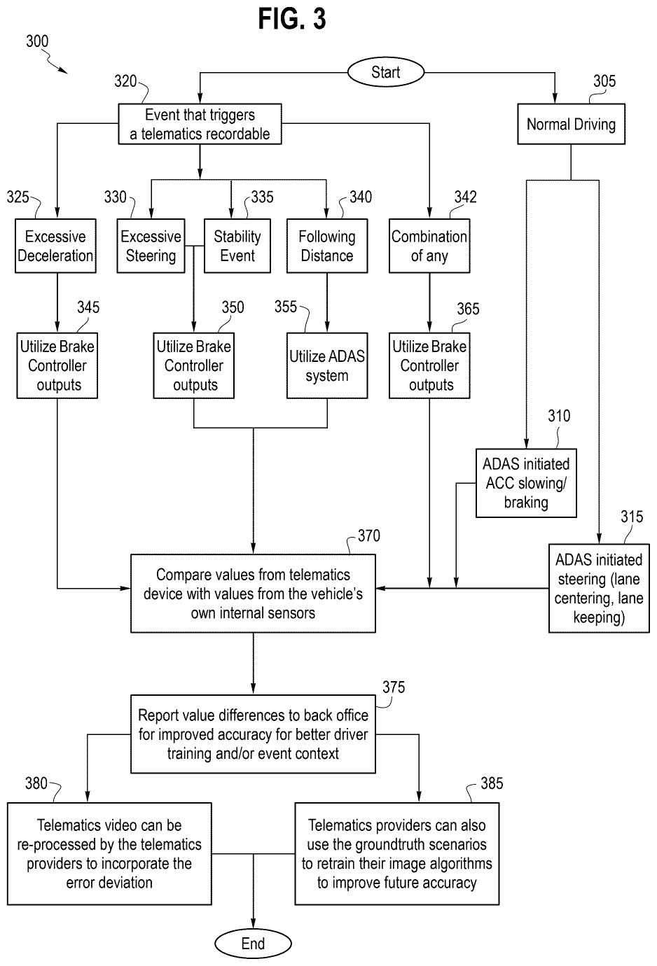

FIG. 3 is a flow chart 300 that illustrates an example use case of these embodiments. It should be noted that this is merely an example and that other implementations can be used. As such, the details presented herein should not be read into the claims unless expressly recited herein. In this example, the following acronyms are used:
ADAS=Advanced Driver Assistance System, which comprises various sensors, including radar, camera, lidar, ultrasonic, etc. for functions, such as ACC, AEB, LDW, etc.
ACC=Adaptive Cruise Control, which is a system utilizing cruise control to maintain speed when not following another vehicle or to maintain headway/distance/time gap when following another vehicle utilizing the ADAS sensors.
ACC1=Adaptive Cruise Control Message 1, which is an 8-byte message containing a set of SPNs that describe ACC operation as defined in the Society of Automotive Engineers (SAE) J1939 specification.
AEB=Automatic Emergency Braking, which is a system that utilizes the ADAS sensors to automatically apply braking to the vehicle if a collision threat is detected and imminent.
AEBS1=Automatic Emergency Braking System Message 1, which is an 8-byte message containing a set of SPNs that describe AEBS operation as defined in the SAE J1939 specification.
LDW=Lane Departure Warning, which is typically an audible warning given when a driver departs a lane without signaling. Lanes are detected utilizing the ADAS sensors, specifically by the camera.
SPN=Suspect Parameter Number, which is a number assigned to a specific signal in the SAE J1939 specification. This is more for an explicit reference.
TTC=Time-to-collision, which is a calculated time until a collision occurs based on the detection from the ADAS sensors and the relative speed of the forward object.
VDC2=Vehicle Dynamic Control Message 2, which is an 8-byte message containing a set of SPNs that describe the dynamic state of the vehicle as defined in the SAE J1939 Specification.

Referring now to the flow chart 300 in FIG. 3, after the start of the method, if normal driving (305) is occurring, ADAS-initiated ACC slowing/braking (310) or steering (lane centering, lane keeping) (315) can occur. An event can occur that is recordable by the telematics device 150 (320). Such an event can be excessive deceleration (325), excessive steering (330), a stability event (spin or rollover) (335), following too closely (340), or a combination thereof (342). If an excessive deceleration event occurs, the telematics calibration system 200 can utilize an output of the brake controller 120 (345). For example, the telematics calibration system 200 can utilize VDC2 to capture ground truth on the vehicle 100 with sensors to the telematics output; here, using SPNs 1810 (Longitudinal Acceleration). The telematics calibration system 200 can also utilize an output of the brake controller 120 if an excessive steering event or a stability event occurs (330, 335). For example, the telematics calibration system 200 can utilize VDC2 to capture groundtruth on the vehicle 100 with sensors to the telematics output; here, using SPNs 1807 (Steer Wheel Angle), 1808 (Yaw Rate), and 1809 (Lateral Acceleration).

If a following distance event occurs, the telematics calibration system 200 can utilize an output of the ADAS system (355). For example, the telematics calibration system 200 can utilize AEBS1 and ACC1 to capture groundtruth on the vehicle 100 with sensors to the telematics output; here, SPNs 5676 (AEB State), 5677 (Collision Warning Level), 5680 (Time to Collision), 1586 (Speed of Forward Vehicle), 1587 (Distance to Forward Vehicle), 1796 (ACC Distance Alert), and 5022 (Forward Collision Warning). If a combination of events occurs (360), the telematics calibration system 200 can utilize an output of the brake controller 120. For example, the telematics calibration system 200 can utilize VDC2, AEBS1, and ACC1 to capture groundtruth on the vehicle 100 with sensors to the telematics output; here, SPNs 1807 (Steer Wheel Angle), 1808 (Yaw Rate), 1809 (Lateral Acceleration), 1810 (Longitudinal Acceleration), 5676 (AEB State), 5677 (Collision Warning Level), 5680 (Time To Collision), 1586 (Speed of Forward Vehicle), 1587 (Distance to Forward Vehicle), 1796 (ACC Distance Alert), and 5022 (Forward Collision Warning).

The telematics calibration system 200 can compare values from the telematics device 150 with values from the vehicle's own internal sensors (370). For example, the telematics calibration system 200 can compare lateral, longitudinal, distance, time and/or other values from telematics device 150 against the above-measured SPNs and perform (or directly or indirectly cause to be performed) a calibration operation. The telematics calibration system 200 can report the value differences to a back office for improved accuracy for better driver training and/or event context (375). For example, if the telematics device 150 reported that a “hard brake event” occurred at 0.5 g, but SPN 1810 shows same event measured at 0.2 g, the event was not as severe as reported (i.e., the measurement from the telematics device 150 is 0.3 g different from the groundtruth on the vehicle 100). As another example, if the telematics device 150 reports a “following distance too close” alert triggered at four meters, but the ADAS system shows the forward vehicle never came closer than ten meters, the artificial intelligence/optics/image processing used to evaluate that situation by the telematics device 150 had an error of ˜150% at that distance and can be corrected.

Based on the calculated difference, the telematics device 150 can re-process the telematics video to incorporate the error deviation (380). Also, the provider of the telematics device 150 can use the groundtruth scenarios to retrain their image algorithms to improve future accuracy (385).

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein. Additionally, “in response to” can be directly in response to or indirectly in response to.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A method for calibrating a telematics device, the method comprising:
performing in a telematics calibration system:
receiving a value from a sensor in a telematics device;
receiving a value from a sensor in a vehicle, wherein the sensor in the vehicle is external to the telematics device;
comparing the value from the sensor in the telematics device with the value from the sensor in the vehicle to identify a difference; and
calibrating the telematics device using the difference.

2. The method of claim 1, wherein calibrating the telematics device comprises re-performing an operation of the telematics device to account for the difference.

3. The method of claim 1, wherein calibrating the telematics device comprises adjusting an output of the telematics device to account for the difference.

4. The method of claim 1, wherein calibrating the telematics device comprises re-training an algorithm used by the telematics device to account for the difference.

5. The method of claim 1, further comprising reporting the difference to a provider of the telematics device.

6. The method of claim 1, wherein the sensor in the telematics device and the sensor in the vehicle comprise respective acceleration sensors.

7. The method of claim 1, wherein the value from the sensor in the vehicle is provided by a brake controller in the vehicle.

8. The method of claim 1, wherein the value from the sensor in the vehicle is provided by a driver assistance system in the vehicle.

9. The method of claim 1, wherein the value from the sensor in the telematics device and/or the value from the sensor in the vehicle is communicated via a communications network in the vehicle.

10. The method of claim 1, wherein the telematics calibration system is part of the vehicle.

11. The method of claim 1, wherein the telematics calibration system is part of the telematics device.

12. The method of claim 1, wherein the telematics calibration system is external to both the vehicle and the telematics device.

13. The method of claim 1, further comprising:
storing the value for use as a starting point for a subsequent calibration.

14. A non-transitory computer-readable storage medium storing a computer program having instructions that, when executed by one or more processors, cause the one or more processors, individually or in combination, to:
receive data from an aftermarket telematics device;
receive data from an integrated vehicle component;
correlate the data received from the aftermarket telematics device with the data received from the integrated vehicle component; and
calibrate the telematics device based on the correlation.

15. The non-transitory computer-readable storage medium of claim 14, wherein the non-transitory computer-readable storage medium and the one or more processors are located in the vehicle.

16. The non-transitory computer-readable storage medium of claim 14, wherein the non-transitory computer-readable storage medium and the one or more processors are located in the aftermarket telematics device.

17. The non-transitory computer-readable storage medium of claim 14, wherein the non-transitory computer-readable storage medium and the one or more processors are located remotely from both the vehicle and the aftermarket telematics device.

18. A system comprising:
one or more processors;
a non-transitory computer-readable medium; and
program instructions stored on the non-transitory computer-readable medium that, when executed by the one or more processors, cause the one or more processors to:
receive data from a telematics device;
receive data from a vehicle component;
correlate the data received from the telematics device with the data received from the vehicle component; and
calibrate the telematics device based on the correlation.

19. The system of claim 18, wherein the system is located in the vehicle.

20. The system of claim 18, wherein the system is located in the telematics device.

21. The system of claim 18, wherein the system is located external to both the vehicle and the telematics device.
